(19) United States
(12) Patent Application Publication
(10) Pub. No.: US 2012/0234476 A1
(43) Pub. Date: Sep. 20, 2012

(54) SELF-ADHESIVE TRANSFER PAPER

(76) Inventor: Zvonimir Martinovic, Varazdin (HR)

(21) Appl. No.: 13/512,376

(22) PCT Filed: Nov. 26, 2010
(86) PCT No.: PCT/EP10/68309

§ 371 Date: May 31, 2012

(30) Foreign Application Priority Data
Nov. 27, 2009 (EP) 09177345.7

(51) Int. Cl. B41M 5/395; B41M 5/382; B44C 1/17; B41M 3/12

(52) U.S. Cl. 156/230; 427/147; 428/32.12; 428/32.86

(57) ABSTRACT

The invention relates to a method for producing self-adhesive transfer papers, to the transfer papers produced by means of the method, and to a transfer print method.

The present invention relates to a method for producing self-adhesive transfer papers, to the self-adhesive transfer papers produced by the method and to transfer printing methods.

Transfer printing refers to the printing of different materials, such as textiles, using transfer papers. Transfer papers are coated with pigments, which are then transferred onto the printable materials, by means of sublimation, using a thermal transfer press.

WO 00/06392 discloses a transfer paper, in particular for ink-jet printing, which paper is provided with a release or barrier layer at least on the side to be printed, the layer having a porosity of at most 100 ml/min.

WO 2008/006434 discloses a transfer paper, which comprises a coating containing a semi-synthetic polymer which has thermoplastic properties. Ethyl cellulose, thermoplastic starch, methyl hydroxypropyl cellulose or hydroxypropyl cellulose are examples of thermoplastic polymers of this type. A coating containing polyacrylates or carboxymethyl cellulose is identified as being disadvantageous.

EP 09 004 614.5 discloses a transfer paper, in particular for ink-jet printing, which is coated with an aqueous liquid which contains ammonium polyacrylate.

EP 09 164 772.7 discloses a transfer paper, in particular for ink-jet printing, which is coated with an aqueous liquid which contains a hydrophilic organic polymer, in particular an acrylate-based polymer, and a cellulose.

For printing polyester- or polyamide-based textiles, the use of self-adhesive transfer papers which adhere to the materials to be printed at the prevailing printing temperatures has been proposed. However, previous attempts to use self-adhesive transfer papers of this type have not been very successful, owing to a lack of adhesive properties and/or low durability.

Surprisingly, it has been found that in the case of multiple coating of the transfer papers on the front thereof, which is to be printed, using different aqueous liquids, the above-described disadvantages can be avoided, at least to a great extent.

A first aspect of the invention therefore relates to a method for producing self-adhesive transfer paper, in particular for ink-jet printing, comprising the following steps:

(a) application of a first aqueous liquid to the front, which is to be printed, of a paper, the first aqueous liquid containing a hydrophilic organic polymer, and subsequent drying,

(b) optional application of a second aqueous liquid to the back of the paper, the second aqueous liquid optionally containing a hydrophilic organic polymer, and subsequent drying, and

(c) application of a third aqueous liquid to the front, which is to be printed, of the paper, the third aqueous liquid containing a thermoactive adhesive and polyvinyl alcohol, and subsequent drying.

The starting material used to produce the transfer paper is a common paper, for example white or unbleached paper, usually having a weight of 60-140 g, in particular 80-120 g per m² paper.

According to step (a) of the method according to the invention, the front to be printed, that is to say the side which is subsequently coated with pigments, is brought into contact with a first aqueous liquid which contains a hydrophilic organic polymer, in particular a polyacrylate- or polymethacrylate-based polymer. Preferably, a polyacrylate and more preferably ammonium polyacrylate is used. The polymer used for the coating, for example ammonium polyacrylate, usually has a weight-average molecular weight of 500 Da or greater, for example 1000-5000 Da and in particular 1000-2000 Da. The first aqueous liquid preferably contains the polymer, for example ammonium polyacrylate, in a proportion of 10-50% by weight, in particular a proportion of 20-40% by weight, based on the total weight of the liquid. The first aqueous solution can be applied using conventional methods, for example by means of a doctor such as a doctor blade or a roll doctor, or by spraying. After the application, the paper is usually dried at an increased temperature, for example 40-80° C.

Step (b) preferably comprises the application of a second aqueous liquid to the back of the paper, and subsequent drying. Preferably, the second aqueous liquid contains a hydrophilic organic polymer, for example a polyacrylate- or polymethacrylate-based polymer. Preferably, a polyacrylate, more preferably ammonium polyacrylate, is used. The second aqueous liquid contains the polymer, for example ammonium polyacrylate, or another organic polymer, preferably in a proportion of 2 to 20%, in particular a proportion of 5 to 15% by weight based on the total weight of the liquid. The application of the second liquid and the subsequent drying can be carried out according to known methods, as in the case of the first liquid.

The first and optionally the second aqueous liquid are usually applied to the paper in a quantity of 10-40 g, in particular of 15-25 g per m², it also being possible for higher or lower quantities to be applied in some embodiments. It is also preferable for the polymer, for example ammonium polyacrylate (or another hydrophilic polymer), to be applied to the front of the paper in a quantity of 1-25 g, in particular of 2-20 g dry weight. The polymer, for example ammonium polyacrylate (or another hydrophilic polymer) is applied to the back, preferably in a quantity of 0.5-15 g, in particular 1-10 g dry weight.

The first aqueous liquid and optionally also the second aqueous liquid can have an acidic, neutral or alkaline pH value. Preferably, the first and second aqueous liquids have an acidic to neutral pH value, for example a pH value of 4-7, for example 5-6.

Step (c) comprises the application of a third aqueous liquid which contains a thermoactive adhesive, for example a silicon adhesive or another adhesive, which, at an increased temperature of, for example, 60-110° C. or higher, has adhesive properties and adheres to the materials to be printed, for example textiles. After cooling to lower temperatures, for example room temperature, the thermoactive adhesive loses its adhesive properties again. Suitable thermoactive adhesives are commercially available, for example from Bayer or Ciba-Geigy.

Furthermore, the third aqueous liquid contains a polyvinyl alcohol. The polyvinyl alcohol usually has a weight-average molecular weight of approximately 10,000-100,000 Da, preferably 30,000-60,000 Da. Suitable polyvinyl alcohols are commercially available, for example the product MOWIOL® 26/28.

In more preferred embodiments, the third liquid contains the following components, selected from

(i) a thermoactive adhesive such as a silicon adhesive, for example in proportions of 1-20% by weight, in particular 2-15% by weight, and

(ii) a polyvinyl alcohol, for example in proportions of 5-30% by weight, in particular 10-20% by weight,
the proportions by weight each being based on the total weight of the first liquid.

In addition to the mentioned additives, the remainder of the liquid preferably consists of water. The proportion of water in the first liquid is preferably ≧40% by weight, in particular ≧50% by weight. There are preferably no organic volatile solvents.

The third aqueous liquid is usually applied to the paper in a quantity of 10-40 g/m², in particular 20-30 g/m², higher or lower quantities also being applied in some embodiments. The third liquid is dried according to known methods as described for the first and second liquids.

In the following, preferred specific examples of aqueous liquids according to the invention for coating the front of paper are given as follows:

Coating liquid 1

| | | |
|---|---|---|
| Ammonium polyacrylate | 20-40% | by weight |
| Remainder H₂O | | |
| pH 5-6 | | |

Coating liquid 2

| | | |
|---|---|---|
| NaOH | 0.02-0.2% | by weight |
| Ammonium polyacrylate | 5-15% | by weight |
| Remainder H₂O | | |
| pH 5-6 | | |

Coating liquid 3

| | | |
|---|---|---|
| Thermoactive adhesive | 2-15% | by weight |
| Polyvinyl alcohol | 10-20% | by weight |
| Remainder H₂O | | |

A further aspect of the invention is a self-adhesive transfer paper, in particular for ink-jet printing, which is obtainable by means of a method as described above.

Another further aspect of the invention is a self-adhesive transfer paper, in particular for ink-jet printing, which is coated on the front, which is to be printed, with a thermoactive adhesive, an acrylate-based polymer, in particular ammonium polyacrylate, for example in a quantity of 1-25 g/m² paper, and a polyvinyl alcohol, in particular in a quantity of 0.5-2 g/m² paper. On the back, the transfer paper is optionally coated with a hydrophilic polymer, for example an acrylate-based polymer such as ammonium polyacrylate, in particular in a quantity of 0.5-15 g/m² paper.

Another further aspect of the invention is a method for printing transfer paper, a layer of sublimable pigments being applied to the front of a self-adhesive transfer paper as previously described, for example by means of ink-jet printing. The pigments can be applied in conventional printing inks using common equipment, for example ink-jet printers, according to known methods. After the application, the printed transfer paper is dried at room temperature or at an increased temperature up to 80° C. Surprisingly, it has been found that the pigments do not demonstrate a tendency to blur during application and drying.

The printed self-adhesive transfer paper can be used in a known manner for printing objects, in particular textiles.

Another further aspect of the present invention is thus a printed self-adhesive transfer paper for printing objects, in particular textiles, which is coated on the front with a thermoactive adhesive, an acrylate-based polymer, for example ammonium polyacrylate, and a polyvinyl alcohol, as well as with sublimable pigments.

The textiles to be printed are usually undyed or white. Optionally, however, predyed textiles can also be used. The textiles are conventional textiles, for example also polyester- and/or polyamide-based textiles, which preferably contain at least 40-60% by weight polyester- and/or polyamide fibres, or are coated with polyester and/or polyamide.

Surprisingly, stretchable textiles can also be coated with the self-adhesive transfer paper according to the invention without blurring. After it has been heated to a temperature of ≧60-110° C., the self-adhesive paper adheres to the material to be printed, in such a way that the colour transfer from paper to the material to be printed by means of conventional roller printing methods is possible without blurring the pigments. Once the colour transfer process is complete, the self-adhesive paper can, after cooling, be readily removed from the material to be printed.

Another further subject-matter of the invention is thus a method for printing objects, in particular textiles, for example polyester or polyamide-based textiles, characterised in that the object to be printed is brought into contact with a printed self-adhesive transfer paper as described above at an increased temperature, for example 160-240° C., in such a way that sublimable pigments are transferred from the transfer paper to the object to be printed.

1. Method for producing self-adhesive transfer paper, in particular for ink-jet printing, comprising the following steps:
(a) application of a first aqueous liquid to the front, which is to be printed, of a paper, the first aqueous liquid containing a hydrophilic organic polymer, and subsequent drying,
(b) optional application of a second aqueous liquid to the back of the paper, the second aqueous liquid optionally containing a hydrophilic organic polymer, and subsequent drying, and
(c) application of a third aqueous liquid to the front, which is to be printed, of the paper, the third aqueous liquid containing a thermoactive adhesive and polyvinyl alcohol, and subsequent drying.

2. Method according to claim 1,
characterised in that
the first aqueous liquid contains a polyacrylate, for example ammonium polyacrylate, as a hydrophilic organic polymer, for example in a proportion of 10-50% by weight, in particular a proportion of 20-40% by weight, based on the total weight of the liquid.

3. Method according to claim 1,
characterised in that
the second aqueous liquid contains a polyacrylate, such as ammonium polyacrylate, as a hydrophilic organic polymer, for example in a proportion of 2-20% by weight, in particular in a proportion of 5-15% by weight, based on the total weight of the liquid.

4. Method according to claim 1,
characterised in that
the first and optionally the second aqueous liquid is applied to the paper in a quantity of 10-40 g, in particular 15-25 g per m².

5. Method according to claim 1,
characterised in that
the hydrophilic polymer, such as ammonium polyacrylate, is applied to the front of the paper in a quantity of 1-25 g, in particular 2-20 g dry weight.

6. Method according to claim 1,
characterised in that
the first and optionally the second aqueous liquid have a pH value of 5-6.

7. Method according to claim 1,
characterised in that
the third liquid contains the following components, in particular selected from
(i) a thermoactive adhesive such as a silicon adhesive, for example in proportions of 1-20% by weight, in particular 2-15% by weight, and
(ii) a polyvinyl alcohol, for example in proportions of 5-30% by weight, in particular 10-20% by weight,
the proportions by weight being based on the total weight of the first liquid.

8. Method according to claim 1,
characterised in that
the third aqueous liquid is applied to the paper in a quantity of 10-40 g/m², in particular 20-30 g/m².

9. Self-adhesive transfer paper, in particular for ink-jet printing, obtainable by a method according to claim 1.

10. Self-adhesive transfer paper, in particular for ink-jet printing,
characterised in that
it is coated on the front, which is to be printed, with a thermoactive adhesive, an acrylate-based polymer and a polyvinyl alcohol.

11. Method for printing transfer paper,
characterised in that
a layer of sublimable pigments is applied to the front of a self-adhesive transfer paper according to claim 9, for example by means of ink-jet printing.

12. Printed self-adhesive transfer paper for printing objects, in particular textiles,
characterised in that
it is coated on the front with a thermoactive adhesive, an acrylate-based polymer, a polyvinyl alcohol and sublimable pigments.

13. Method for printing objects, in particular textiles,
characterised in that
the object to be printed is brought into contact with a printed self-adhesive transfer paper according to claim 12 at increased temperature, in such a way that sublimable pigments are transferred from the transfer paper to the object to be printed.

14. Method according to claim 13,
characterised in that
the pigments are transferred from the paper to the object to be printed by means of roller printing.
